(19) United States
(12) Patent Application Publication
(10) Pub. No.: US 2013/0263208 A1
(43) Pub. Date: Oct. 3, 2013

(54) MANAGING VIRTUAL MACHINES IN A CLOUD COMPUTING SYSTEM

(71) Applicant: Narsimha Reddy Challa, Hyderabad (IN)

(72) Inventor: Narsimha Reddy Challa, Hyderabad (IN)

(21) Appl. No.: 13/478,723

(22) Filed: May 23, 2012

(30) Foreign Application Priority Data
Apr. 2, 2012 (IN) 1313/CHE/2012

(51) Int. Cl. G06F 9/455; G06F 21/00

(52) U.S. Cl. 726/1; 718/1

(57) ABSTRACT

Provided is a method of managing a virtual machine in a cloud computing system. Virtual servers present in a cloud computing system are organized into policy domains, wherein a policy domain is a group of virtual servers that share a common policy. Upon receipt of a request for creating a new virtual machine, a determination is made whether a policy of the new virtual machine corresponds to a policy of a policy domain. The new virtual machine is created in a policy domain whose policy corresponds with the policy of the new virtual machine.

### BACKGROUND

Cloud computing has become quite popular in recent years. Generally speaking, cloud computing involves delivery of computing as a service rather than a product, whereby shared resources (software, storage resources, etc.) are provided to computing devices as a service. The resources are shared over a network, which is typically the internet. One of the key reasons behind the success of cloud computing is a technology called virtualization. Virtualization allows creation of a virtual version of a resource, such as an operating system, a hardware platform, storage resource etc. which could be shared, for instance, among different clients. Multiple virtual machines (VM) can be created on a host device or server.

### BRIEF DESCRIPTION OF THE DRAWINGS

For a better understanding of the solution, embodiments will now be described, purely by way of example, with reference to the accompanying drawings, in which:

FIG. 1 illustrates a system for managing virtual machines in a cloud computing system, according to an embodiment.

FIG. 2 shows a flow chart of a method of managing virtual machines in a cloud computing system, according to an embodiment.

FIG. 3 illustrates arrangement of virtual servers into exclusive and non-exclusive policy domains in a cloud computing system, according to an embodiment.

FIG. 4 illustrates multiple policy domains in a single virtual server, according to an embodiment.

FIG. 5 shows a flow chart of a method of managing virtual machines in a cloud computing system, according to an embodiment.

### DETAILED DESCRIPTION OF THE INVENTION

A virtual machine (VM) is a software implementation of a machine that executes programs like a physical machine. As mentioned earlier, virtualization allows creation of multiple virtual machines (VM) on a host physical computing device. In a cloud computing architecture, a service provider can use virtualization to create virtual machines on host physical machines (for example, a server computer) and offer these virtual machines to its customers. The customers can use virtual machines for a variety tasks, for example, to run multiple operating systems at the same time, to test a new application on multiple platforms, etc.

In a typical cloud computing scenario, a cloud service provider may offer virtual machines to its clients based on their needs. When a client requests for an additional virtual machine(s), the service provider either creates a new virtual machine(s) or assigns an existing (unused) virtual machine to the client. In general when a new virtual machine is required to be created, the cloud service provider simply checks its existing free server resources and creates a new virtual machine on an available server without considering any pre-conditions, such as policies, client security needs or a service level agreement (SLA). Even when a virtual machine is moved from one host to another, these pre-conditions are generally not taken into account. Needless to say, this is not an ideal condition from a customer's perspective who may ideally like to separate its virtual machines from other users of the cloud computing system for security or other reasons.

Embodiments of the present solution provide methods and systems for managing virtual machines in a cloud computing system. Specifically, the embodiments described provide a solution to place new virtual machines in a cloud architecture and control their movement among different host machines in order to satisfy policies like security, client confidentiality, and any other requirement specified in a service level agreement between a customer and a cloud service provider.

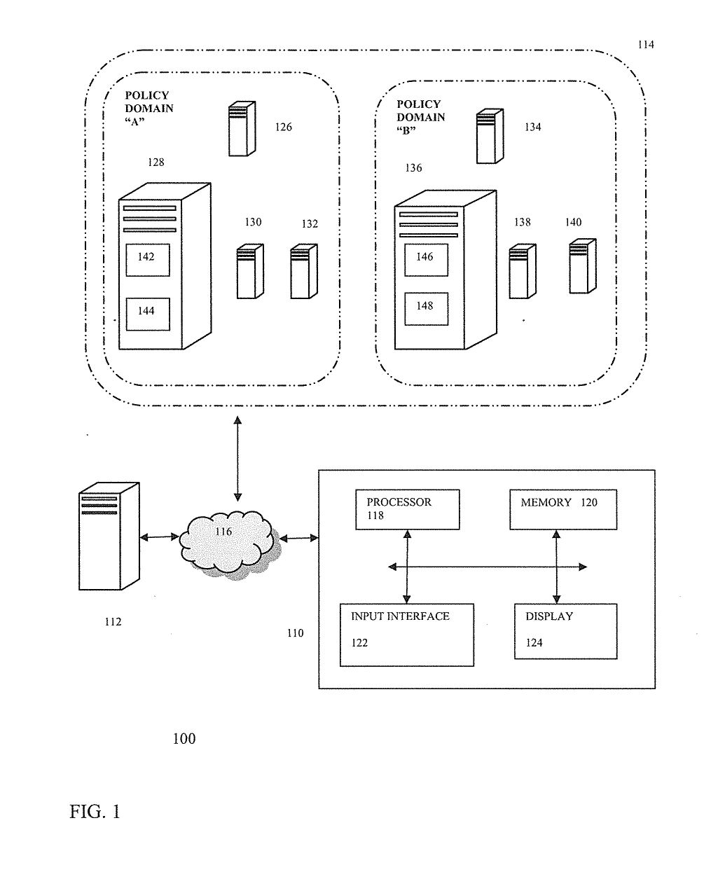

FIG. 1 illustrates a system 100 for managing virtual machines in a cloud computing system, according to an embodiment.

System 100 may include a user computer system 110, server computer 112, and a cloud computing system 114. User computer system 110, server computer 112 are communicatively coupled to the cloud computing system 114 through a network 116.

User computer system 110 may include a desktop computer, a notebook computer, a server computer, a personal digital assistant (PDA), a mobile device, a touch pad, or any other computing device. User computer system 110 is used by a user (for example, a system administrator, a customer, a client, etc.) to control and manage the cloud computing system 114.

User computer system 110 may include a processor 118 for executing machine readable instructions, a memory (storage medium) 120 for storing machine readable instructions, an input interface 122 and a display 124. These components may be coupled together through a system bus.

Processor 118 is arranged to execute machine readable instructions. In an example, processor 118 executes machine readable instructions to: organize virtual servers, present in the cloud computing system, into policy domains, wherein a policy domain is a group of virtual servers that share a common policy; determine, upon receipt of a request for creating a new virtual machine, whether a policy relating to the new virtual machine corresponds to a policy domain; and create the new virtual machine in a policy domain whose policy corresponds with the policy of the new virtual machine.

Memory 120 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 120 may include machine readable instructions to manage the computing resources present in the cloud computing system 110.

The input interface 122 may be used to provide a user input to the computing system 110. The input interface 122 may include an input device, such as a keyboard or a mouse, and other user interaction mechanisms, such as a touch interface, a voice interface (such as microphone), a gesture interface, etc. The input interface also includes a software interface (such as a graphical user interface (GUI)).

Display device 124 may be any device that enables a user to receive visual feedback. For example, the display may be a liquid crystal display (LCD), a light-emitting diode (LED) display, a plasma display panel, a television, a computer monitor, and the like.

Server computer 112 may include a general purpose PC or a computer server. It may include a processor for executing machine readable instructions and a memory (storage medium) for storing machine readable instructions. The memory may include a cloud service policy database that contains rules relating to a customer service level agreement (SLA). Memory may also include a custom trust manager for each policy domain within a cloud computing system. The custom trust manager is installed on an agent running on a virtual server. Its role is to verify certificates inside a policy domain, which were issued by its policy domain leader.

Cloud computing system 114 may include various computing resources. These computing resources may be hardware resources, software resources, or any combinations thereof. Hardware resources may include computer systems, computer servers, workstations, or any other computer devices. Software resources may include operating system software (machine executable instructions), firmware, and/or application software.

Cloud computing system 114 may include computing resources, such as virtual servers, virtual machines, storage resources, etc. In the present example, cloud computing system 114 may include virtual servers 126, 128, 130, 132, 134, 136, 138 and 140. Virtual servers may be grouped together according to a policy (or policies). This grouping constitutes a policy domain. For example, virtual servers may be grouped together according to a security policy defined in a customer's service level agreement (SLA). Virtual servers that satisfy this security policy are grouped together to form a policy domain. In the present example, virtual servers 126, 128, 130, 132 are grouped together to form a policy domain A, and virtual servers 134, 136, 138 and 140 are grouped together to form a policy domain B. In other words, virtual servers 126, 128, 130, and 132 satisfy a policy (or policies) which is distinct from policy (or policies) satisfied by virtual servers 134, 136, 138 and 140. Policy (policies) may be user defined (for instance, a customer of the cloud computing system 114) or system defined.

A virtual server in a cloud computing system 114 may include a virtual machine(s) (VM). In the present example, virtual server 128 includes virtual machines 142 and 144, and virtual server 136 includes virtual machines 146 and 148. A virtual machine (VM) is a guest operating system installation within a host operating system. It is a software implementation of a machine that executes programs like a physical machine.

It may be noted that although a single user computer system 110 and cloud computing system 114, and a particular number of virtual servers and virtual machines are illustrated in FIG. 1, their actual number may vary according to the implementation requirements of a user.

Network 116 may be an intranet or the internet (World Wide Web). Network 116 may be a wired (for example, co-axial cable) or a wireless (for example, Wi-Fi) network. Network 116 may include a local area network (LAN), a metropolitan area network (MAN), a wide area network (WAN), the intranet, or any combinations thereof.

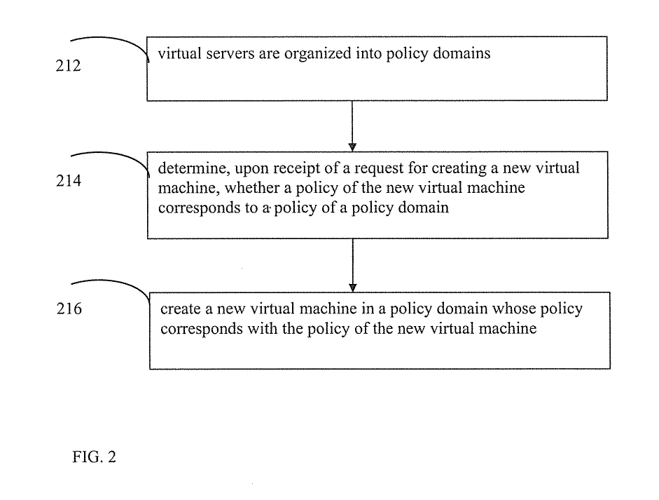

FIG. 2 shows a flow chart of a method of managing virtual machines in a cloud computing system, according to an embodiment.

At block 212, virtual servers in a cloud computing system are grouped according to a policy (policies). Virtual servers present in a cloud computing system are identified and assembled into a group or multiple groups based on a policy (policies). If there's a single policy that applies to all the virtual servers then a single group may be formed. However, if different policies apply to different virtual servers then they are grouped together according to the policy applicable to them. To illustrate with the help of FIG. 1, virtual servers 126, 128, 130 and 132 may be grouped together to satisfy a policy A. On the other hand virtual servers 134, 136, 138 and 140 are grouped together to meet the condition(s) identified in a policy B. The policy (policies) applicable to a virtual server is identified and if the same policy applies to another virtual server, the virtual servers are grouped together.

Virtual servers that have a same policy (policies) form a policy domain. Therefore, a policy domain is a group of virtual servers having same set of policies. In the above illustration, virtual servers 126, 128, 130, 132 are grouped together to form a policy domain A, and virtual servers 134, 136, 138 and 140 are grouped together to form a policy domain 8.

A policy (policies) may be user defined (for instance, a customer of the cloud computing system) or system defined. Policy may be of various types. In an instance, a policy may relate to a security requirement(s) of a customer. In another instance, a policy may mean to isolate one customer's virtual environment from another customer. In a yet another example, policy may mean satisfying conditions present in a service level agreement between a customer and a cloud computing system provider. There are merely some illustrative examples of policies, and a user may define any policy of his choice.

If a virtual server is not pre-configured with a policy, a policy (policies) applicable to the virtual server is identified, and the virtual configured is configured therewith. If another virtual server(s) with the same policy is present, both (or all) of them are grouped together to form a policy domain.

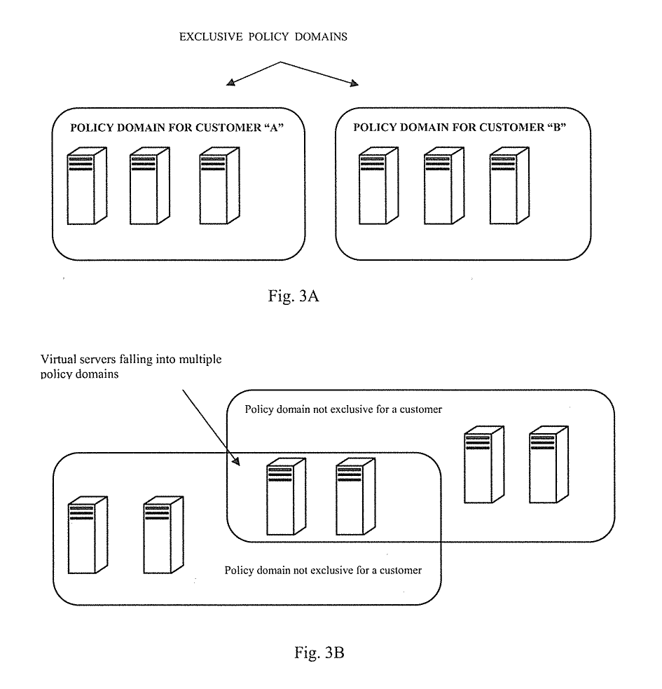

Each policy domain may include a virtual server which acts as the leader of the group. The leader issues a security certificate to all members of a domain. If a new virtual server joins a policy domain (by virtue of its having a policy similar to the group policy), the leader issues a security certificate to the new virtual server as well. A security certificate includes customer identity details if a policy domain includes virtual servers that exclusively belong to a particular customer. These are exclusive policy domains (For example, FIG. 3A illustrates exclusive policy domains for customers A and B). On the other hand, there may be virtual servers that fall into multiple policy domains (FIG. 3B). Security certificates are digitally signed by the leader of a policy domain. The leader also maintains membership details of all virtual servers in its policy domain.

Each virtual server may run an agent. The agent maintains a logical relationship with other virtual servers in the same policy domain. And each agent running on a virtual server has the security certificate of its policy domain, which it uses for a secure communication with other virtual servers in the same policy domain.

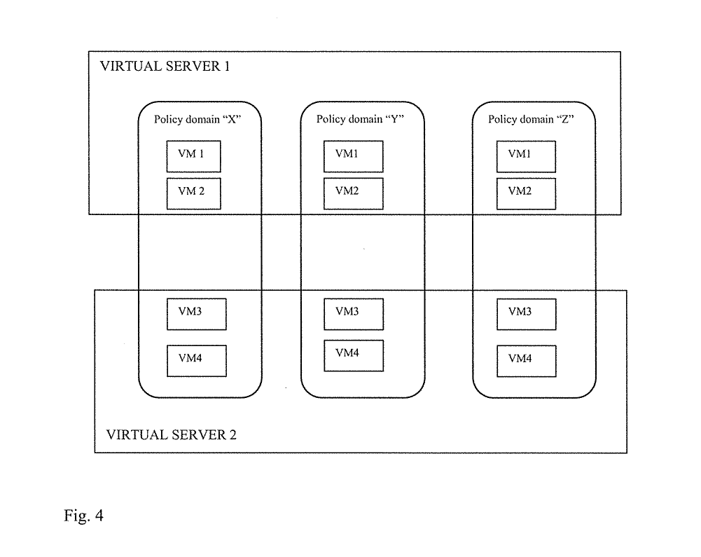

In an alternate example, multiple policy domains may be part of a single virtual server. A virtual server may contain many policy domains in case of users who require less number of virtual machines. A policy domain in such case may cover multiple virtual servers (FIG. 4). For example, policy domain for customers “X”, “Y” and “Z” cover two virtual servers 1 and 2. Also, an agent running on a virtual server may be required to participate in multiple domains. They would be also required to have security certificate for each policy domain that may be present on the virtual server.

A cloud service policy database may be present that stores all the rules related to a customer's service level agreement. For example, what are the customer's security requirements related to data, what's the type of data isolation that customer requires, etc.

At block 214, upon receipt of a request for creating a new virtual machine on a virtual server for a customer, the existing policy domains in the cloud computing system are checked against the service level agreement (SLA) with the customer. In other words, it is determined if there is/are any existing policy domain(s) in the cloud computing system environment that may match with the policy requirements of the new virtual machine which is to be created.

If an existing policy domain matches with the policy requirements of the new virtual machine (i.e. a present policy domain complies with the SLA with the customer who's requesting the new virtual machine), the new virtual machine is created in the matched policy domain. If there are multiple policy domains that match with the policy requirements of the new virtual machine, then the policy domains are ranked. The ranking of policy domains may be based on (a) availability of free resources in a policy domain, and/or (b) the degree of matching (agreement) between the policies of a policy domain and the policy requirement of the new virtual machine (i.e. specifications in the SLA of the customer).

The policy domain which best meets the policy requirement of a new virtual machine is selected to create the new virtual machine (block 216). If none of the policy domains are found suitable (i.e. they do not meet the policy requirement of the new virtual machine), then a new policy domain is created for the new virtual machine.

Once a policy domain is determined which best meets the policy requirement of a new virtual machine, the virtual servers present in the policy domain are ranked as well. The virtual server which is ranked highest is identified and used to create the new virtual machine.

However, prior to creation of a virtual machine on an identified virtual server, the identified virtual server is authenticated using the certificate issued by the leader of the policy domain (of the identified virtual server). If the certificate is verified, a new virtual machine is created.

Movement of a virtual machine from one virtual server to another virtual server.

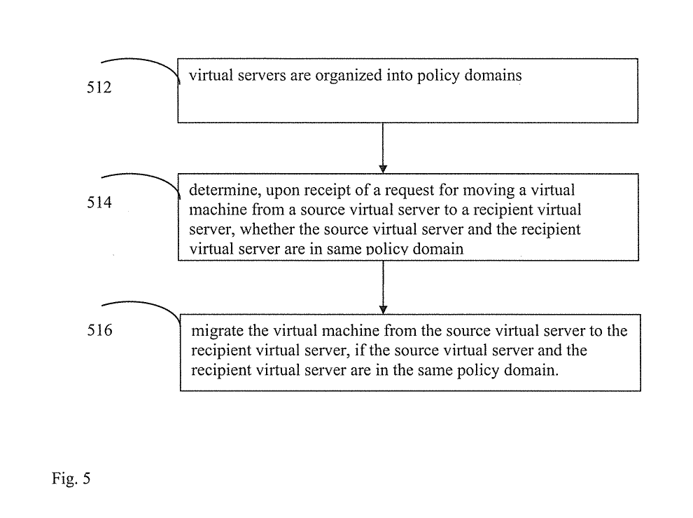

It is presumed that virtual servers are organized into policy domains (wherein a policy domain is a group of virtual servers that share a common policy.) If not then they are first organized into policy domains (FIG. 5, block 512).

As mentioned above, each virtual server may run an agent. The agent maintains a logical relationship with other virtual servers in the same policy domain. And each agent running on a virtual server has the security certificate of its policy domain, which it uses for a secure communication with other virtual servers in the same policy domain.

It is an agent which is responsible for moving (migrating) a virtual machine within a policy domain securely. Upon receipt of a request for moving a virtual machine from a source virtual server to a recipient virtual server, a determination is made whether the source virtual server and the recipient virtual server are in same policy domain (514). To move a virtual machine from one virtual server to another virtual server the agent on the source virtual server authenticates itself with the agent on the recipient virtual server. If both source and recipient virtual servers are in the same policy domain, the authentication takes place (since the agent certificate for both virtual servers was issued by the leader of their policy domain), and the virtual machine is moved (migrated) to the recipient virtual server (516). If the verification fails, it means the source and recipient virtual servers are not in the same policy domain, and the virtual machine migration is not allowed.

It would be appreciated that the system components depicted in FIG. 1 are for the purpose of illustration only and the actual components may vary depending on the computing system and architecture deployed for implementation of the present solution. The various components described above may be hosted on a single computing system or multiple computer systems, including servers, connected together through suitable means.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A computer-implemented method of managing a virtual machine in a cloud computing system, comprising:
organizing virtual servers, present in the cloud computing system, into policy domains, wherein a policy domain is a group of virtual servers that share a common policy;
determining, upon receipt of a request for creating a new virtual machine, whether a policy of the new virtual machine corresponds to a policy of a policy domain; and
creating the new virtual machine in a policy domain whose policy corresponds with the policy of the new virtual machine.

2. The method of claim 1, wherein the virtual machine is created in a virtual server of the policy domain whose policy corresponds with the policy of the new virtual machine.

3. The method of claim 2, wherein prior to creating the virtual machine in the virtual server of the policy domain, all virtual servers of the policy domain are ranked and highest ranked virtual server is selected for creating the virtual machine.

4. The method of claim 2, wherein prior to creating a new virtual machine in the virtual server, the virtual server is authenticated using a certificate issued by a virtual server of the policy domain who is entrusted with issuing the certificate.

5. The method of claim 1, wherein if multiple policy domains correspond with the policy of the new virtual machine, the multiple policy domains are ranked and highest ranked policy domain is selected for creating the virtual machine.

6. The method of claim 5, wherein the policy domains are ranked according to free computing resources available with them.

7. The method of claim 5, wherein the policy domains are ranked according to degree of their agreement with the policy of the new virtual machine.

8. A computer-implemented method of managing a virtual machine in a cloud computing system, comprising:
receiving a request for moving a virtual machine from a source virtual server to a recipient virtual server;
verifying whether the source virtual server and the recipient virtual server are in same policy domain, wherein a policy domain is a group of virtual servers that share a common policy; and
migrating the virtual machine from the source virtual server to the recipient virtual server, if the source virtual server and the recipient virtual server are in the same policy domain.

9. The method of claim 8, wherein verifying whether the source virtual server and the recipient virtual server are in the same policy domain comprises authenticating the recipient virtual server with a certificate issued by a virtual server of the policy domain who is entrusted with issuing the certificate.

10. A system for managing a virtual machine in a cloud computing system, comprising:
a processor;
a memory communicatively coupled to the processor, the memory comprising machine executable instructions that, when executed by the processor, causes the processor to:
organize virtual servers, present in the cloud computing system, into policy domains, wherein a policy domain is a group of virtual servers that share a common policy;
determine, upon receipt of a request for creating a new virtual machine, whether a policy of the new virtual machine corresponds to a policy of a policy domain; and
create the new virtual machine in a policy domain whose policy corresponds with the policy of the new virtual machine.

11. The system of claim 10, further comprising a computer server which includes a module to verify a certificate issued by a virtual server of the policy domain who is entrusted with issuing the certificate.

12. The system of claim 10, wherein if multiple policy domains correspond with the policy of the new virtual machine, the multiple policy domains are ranked and highest ranked policy domain is selected for creating the virtual machine.

13. The method of claim 10, wherein the virtual machine is created in a virtual server of the policy domain whose policy corresponds with the policy of the new virtual machine.

14. The system of claim 13, wherein prior to creating a new virtual machine in the virtual server, the virtual server is authenticated using a certificate issued by a virtual server of the policy domain who is entrusted with issuing the certificate.

15. A computer program product for managing a virtual machine in a cloud computing system, the computer program product comprising:
a computer readable storage medium having computer usable program code embodied therewith, the computer usable program code comprising:
computer usable program code that organizes virtual servers, present in the cloud computing system, into policy domains, wherein a policy domain is a group of virtual servers that share a common policy;
computer usable program code that determines, upon receipt of a request for creating a new virtual machine, whether a policy of the new virtual machine corresponds to a policy of a policy domain; and
computer usable program code that creates the new virtual machine in a policy domain whose policy corresponds with the policy of the new virtual machine.
